(19) United States
(12) Patent Application Publication
(10) Pub. No.: US 2026/0208306 A1
(43) Pub. Date: Jul. 23, 2026

(54) TRANSFER CARRIER PARKING DEVICE

(71) Applicant: GUYOUNG TECHNOLOGY CO., LTD., Daegu (KR)

(72) Inventor: HEE HWA LEE, Chilgok-gun (KR)

(21) Appl. No.: 19/369,367

(22) Filed: Oct. 27, 2025

(30) Foreign Application Priority Data
Jan. 23, 2025 (KR) 10-2025-0010202

(51) Int. Cl. B23Q 3/18; B23Q 7/14

(52) U.S. Cl. CPC B23Q 3/18; B23Q 7/1442

(57) ABSTRACT

Provided is a transfer carrier parking device including: a transfer carrier in which a plurality of workpieces are loaded; and a carrier setter having a pair of first and second site guards located on a parking site for the transfer carrier in such a way as to be arranged in parallel with a parking direction of the transfer carrier, a third site guard located on one side end of the first and second site guards in such a way as to restrict a moving distance of the transfer carrier, a parking reference surface located on the first site guard, and a pair of first setting blocks located on the second site guard in such way as to expandingly and contractedly move by means of setting cylinders connected thereto to press the transfer carrier toward the parking reference surface.

### BACKGROUND OF THE DISCLOSURE

### CROSS REFERENCE TO RELATED APPLICATION OF THE DISCLOSURE

The present application claims the benefit of Korean Patent Application No. 10-2025-0010202 filed in the Korean Intellectual Property Office on January 23, 2025, the entire contents of which are incorporated herein by reference.

### FIELD OF THE DISCLOSURE

The present disclosure relates to a transfer carrier parking device, more specifically to a transfer carrier parking device that is structurally improved so that a transfer carrier in which workpieces are loaded is pressed toward a parking reference surface by means of setting blocks to allow a parking reference point to be set, thereby achieving automation in the setting process and improving a degree of precision in loading the workpieces by a robot arm.

### BACKGROUND OF THE RELATED ART

Typically, a coating process is carried out to protect a material to be coated from various pollutants and substances causing corrosion and to increase the lifespan of the material to be coated, and in the case of parts in an electric field such as battery cases, the coating process is widely applied to form a coating layer on the battery case so that an insulation function is added to the battery case.

As an automated manufacturing line is provided, a variety of transfer facilities are developed and applied to industrial sites to supply materials to be coated and discharge the coated materials, but in the process of transferring the materials to be coated, typically, they are loaded onto a cart to move to a given position and are then unloaded and loaded one by one manually.

A conventional technology as disclosed in Korean Patent No. 10-2123790 is provided with a pair of lifting devices that has an overall height higher than a bottom frame of a palette and an overall length greater than an overall width thereof, and the pair of lifting devices includes: a driving motor; a shaft connected to the driving motor and rotating in an axial direction; a coupling connected to the shaft; an up and down guide coupled to the coupling; a cam connected to the up and down guide; a lifting bar coupled to the cam and provided horizontally to the overall height; a front and back guide coupled to one side of the up and down guide; and a guide rail to which the front and back guide is connected to form a forward and backward moving path of the front and back guide and having an axis parallel to the shaft.

The conventional technology is an ultra-low floor type device passing through a space under the bottom frame of the palette (cart), thereby enhancing a degree of utilization of the internal space of a factory and minimizing the risk of overturning an Automated Guided Vehicle (AGV), but according to the conventional technology, if the workpieces placed on the palette (cart) are loaded by means of a robot arm, the clamping positions of the robot arm may be varied according to the parking positions of the palette (cart), thereby undesirably making a degree of precision in loading the workpieces deteriorated.

### Prior Art Document

### Patent Document

Patent document 0001: Korean Patent No. 10-2123790 B1

Patent document 0002: Korean Patent No. 10-2587903 B1

### SUMMARY OF THE DISCLOSURE

Accordingly, the present disclosure has been made in view of the above-mentioned problems occurring in the related art, and it is an object of the present disclosure to provide a transfer carrier parking device that is structurally improved so that a transfer carrier in which workpieces are loaded is pressed toward a parking reference surface by means of setting blocks to allow a parking reference point to be set, thereby achieving automation in the setting process and improving a degree of precision in loading the workpieces by a robot arm.

To accomplish the above-mentioned objects, according to the present disclosure, there is provided a transfer carrier parking device including: a transfer carrier in which a plurality of workpieces are loaded; and a carrier setter adapted to correct a parking zero point for the workpieces and including a pair of first and second site guards located on a parking site for the transfer carrier in such a way as to be arranged in parallel with a parking direction of the transfer carrier, a third site guard located on one side end of the first and second site guards in such a way as to restrict a moving distance of the transfer carrier, a parking reference surface located on the first site guard, and a pair of first setting blocks located on the second site guard in such way as to expandingly and contractedly move by means of setting cylinders connected thereto to press the transfer carrier toward the parking reference surface.

According to the present disclosure, desirably, the carrier setter may further include a second setting block located on one side first setting block and having a slant setting surface on one side thereof, and while the transfer carrier is pressed toward the parking reference surface by means of expanding transfer forces of the first setting blocks, the slant setting surface of the second setting block may serve to press one side frame of the transfer carrier against the third site guard.

According to the present disclosure, desirably, the transfer carrier parking device may further include a zero point setter adapted to correct a loading zero point of each workpiece unloaded from the transfer carrier by means of a robot arm, the zero point setter including: a setting board for temporarily seating the plate-shaped workpiece transferred through the robot arm thereonto and having a given inclination in such a way as to be kept in posture to allow one side corner of the workpiece to be located toward a lower portion thereof; first and second setting guides arranged to become reduced in distance therebetween toward the lower portion thereof to guide the two neighboring sides of the workpiece, while being spaced apart from each other on lower ends thereof in such a way as to form a detection space portion allowing the corner of the lower portion of the workpiece to be exposed to the outside; and first and second setting sensors for detecting the positions of the two sides of the workpiece exposed through the detection space portion in a state of coming into surface contact with the first and second setting guides.

According to the present disclosure, desirably, the robot arm’s loading reference point may be set with respect to the position of the workpiece corrected in loading posture by means of the first and second setting guides, and after each workpiece is clamped by the robot arm, unloaded from the transfer carrier, and seated onto the setting board, if each workpiece is unclamped from the robot arm, the workpiece may move downward along the first and second setting guides by means of self-weight thereof and be thus corrected in loading posture, so that if the workpiece is detected by means of the first and second setting sensors, the robot arm may move to the loading reference point, clamp the workpiece, and be then transferred to a process line.

According to the present disclosure, desirably, the transfer carrier may include: a bottom frame; side frames erected on both sides of the bottom frame; a top frame located on tops of the side frames and having carrier hooks; bottom spacers located on the bottom frame and each having a plurality of bottom jig grooves adapted to receive the undersides of workpieces therein, the workpieces being erectedly placed in the transfer carrier; and top spacers spaced apart from one another on the top frame in such a way as to correspond to the bottom jig grooves, movable in a longitudinal direction thereof, and each having a top jig groove adapted to receive the top of the corresponding workpiece therein.

According to the present disclosure, desirably, each top spacer may include: sleeves mounted on the top frame; a rod inserted into the sleeves in such a way as to linearly move in a longitudinal direction; a top jaw located on the underside of the rod and having the top jig groove on the underside thereof; and a weight located on top of the rod in such a way as to press the rod downward.

According to the present disclosure, desirably, the bottom jig grooves and the top jig grooves may be V-shaped grooves, and if the workpieces are restrained by the top spacers and the bottom spacers, tops and undersides of the workpieces may be corrected in position to the centers of the V-shaped grooves as the bottom jig grooves and the top jig grooves.

According to the present disclosure, desirably, each top jig groove may have a grasping edge on the inner peripheral surface thereof in such a way as to grasp top of the workpiece and thus restrain the workpiece thereby.

According to the present disclosure, desirably, the transfer carrier may further include a cart unit adapted to support the underside of the transfer carrier thereagainst and having a plurality of casters, a pair of base arms having locking projections adapted to receive the underside of the transfer carrier, and transverse bars for connecting the base arms to each other.

According to the present disclosure, desirably, the workpiece placed in the transfer carrier may be clamped by a suction pad of the robot arm, and in a state where the suction pad of the robot arm is sucked onto one side surface of the workpiece, if the workpiece moves upward together with the top jaws by means of the robot arm, the underside of the workpiece may become separated from the bottom jig grooves and be then inclined at a given angle by means of the robot arm, so that the underside of the workpiece may be separated from the bottom jig grooves to the outside, and next, if the workpiece moves downward by means of the robot arm, the top of the workpiece may be separated from the top jig grooves to the outside and then unloaded from the transfer carrier.

According to the present disclosure, desirably, the workpiece may be clamped by the suction pad of the robot arm, and in the state where the suction pad of the robot arm is sucked onto one side surface of the workpiece, the workpiece may be inclined at a given angle, put between the top spacers and the bottom spacers, and moves upward together with the top jaws in a state where the top of the workpiece is received in the top jig grooves by means of the robot arm, so that if the workpiece is corrected perpendicularly in position and then moves downward by means of the robot arm, the underside of the workpiece is received in the bottom jig grooves and restrained thereby.

According to the present disclosure, desirably, the rod or the top jaw may have a lift pin on one side thereof, and the robot arm may have a robot pushing piece at a position corresponding to the lift pin, so that to load the workpiece in the transfer carrier, if the workpiece is clamped by the robot arm, is inserted into the transfer carrier, and thus moves upward at positions corresponding to the top spacers and the bottom spacers, the lift pins may be pressed against the robot pushing pieces to allow the top jaws to move upward, which causes the top jig grooves and the workpiece to be kept separated from each other, and if the workpiece is corrected perpendicularly in position and then moves downward by means of the robot arm, next, the underside of the workpiece may be received in the bottom jig grooves to allow the upward pressing forces of the robot pushing pieces against the lift pins to be released, which causes the workpiece to be restrained by the top jig grooves through the downward movements of the top jaws.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a perspective view showing a transfer carrier parking device according to the present disclosure;

FIGS. 2A and 2B are side views showing a state where a transfer carrier is parked on the transfer carrier parking device according to the present disclosure;

FIG. 3 is a photograph showing a zero point setter of the transfer carrier parking device according to the present disclosure;

FIGS. 4A and 4B are photographs showing operating states of the zero point setter of the transfer carrier parking device according to the present disclosure;

FIG. 5 is a perspective view showing the transfer carrier of the transfer carrier parking device according to the present disclosure;

FIG. 6 is a front view showing the transfer carrier of the transfer carrier parking device according to the present disclosure;

FIG. 7 is an enlarged perspective view showing a top spacer of the transfer carrier parking device according to the present disclosure;

FIGS. 8A and 8B are side views showing a state where a workpiece is loaded and unloaded in and from the transfer carrier of the transfer carrier parking device according to the present disclosure; and

FIGS. 9A and 9B are side views showing a lift pin and a robot pushing piece in the transfer carrier parking device according to the present disclosure.

### DETAILED DESCRIPTION OF THE PREFERRED EMBODIMENT

Hereinafter, an embodiment of the present disclosure will be explained in detail with reference to the attached drawings.

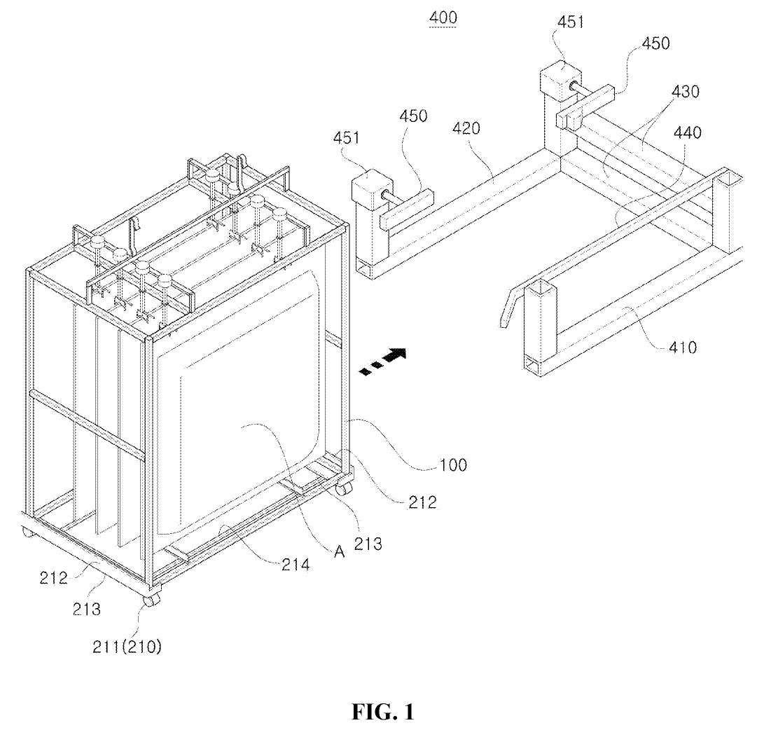

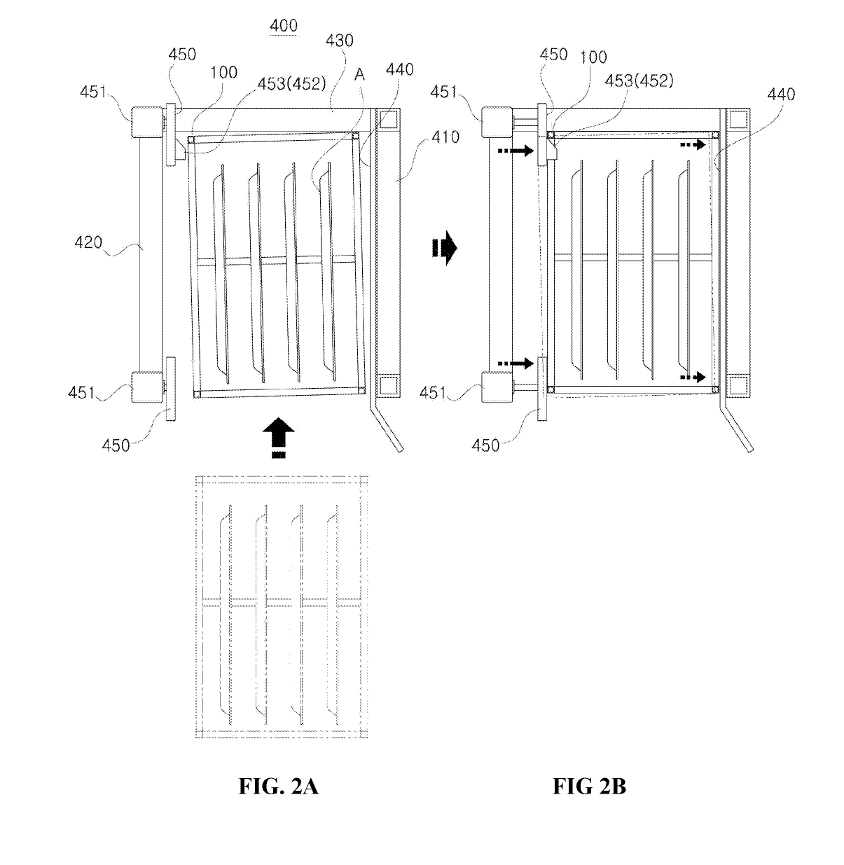

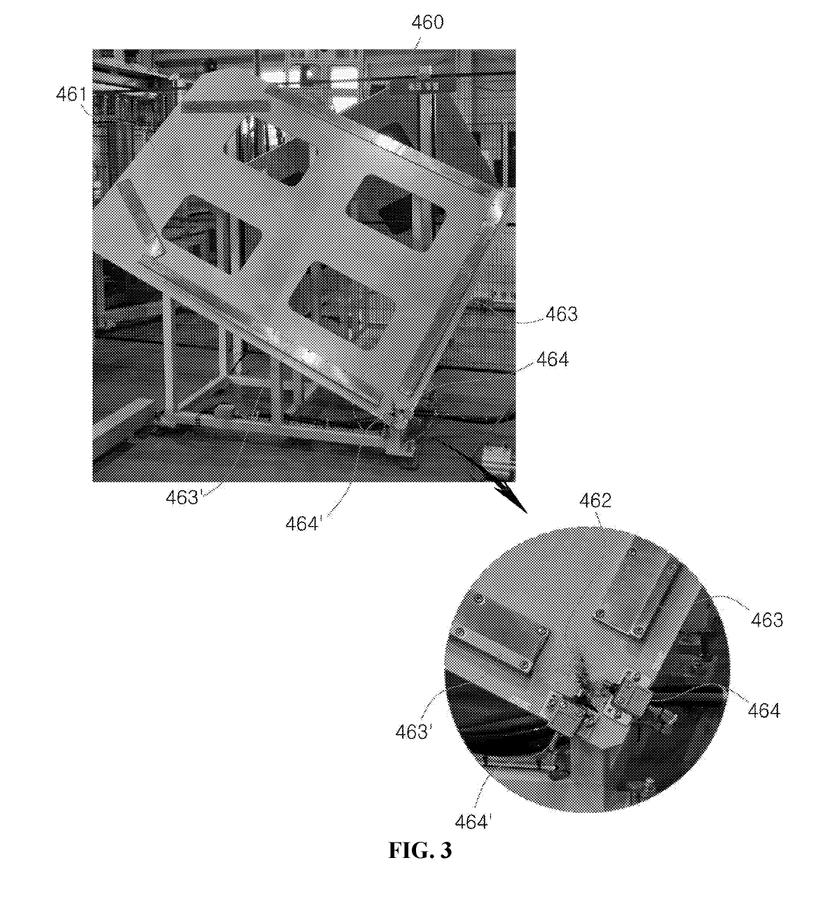

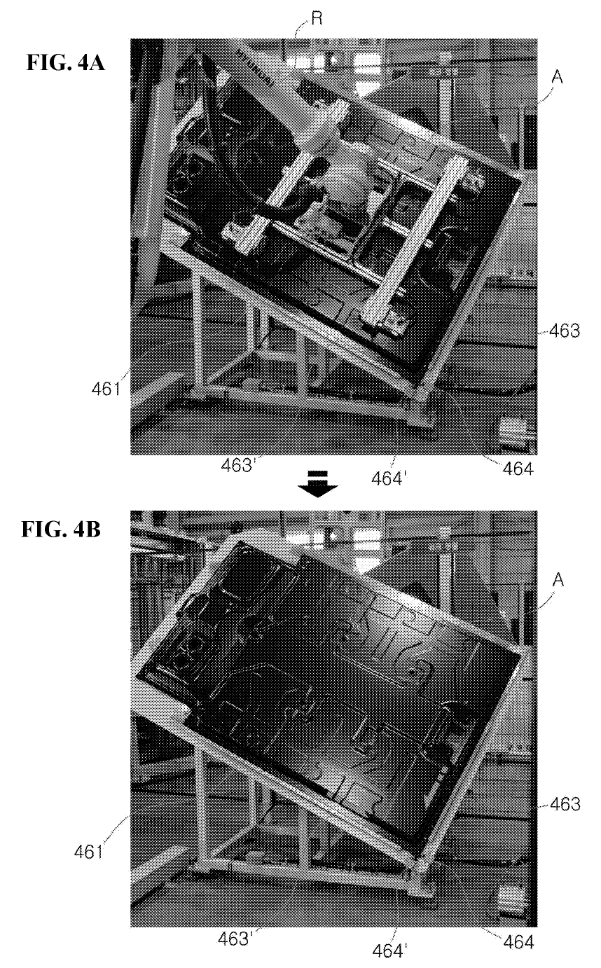

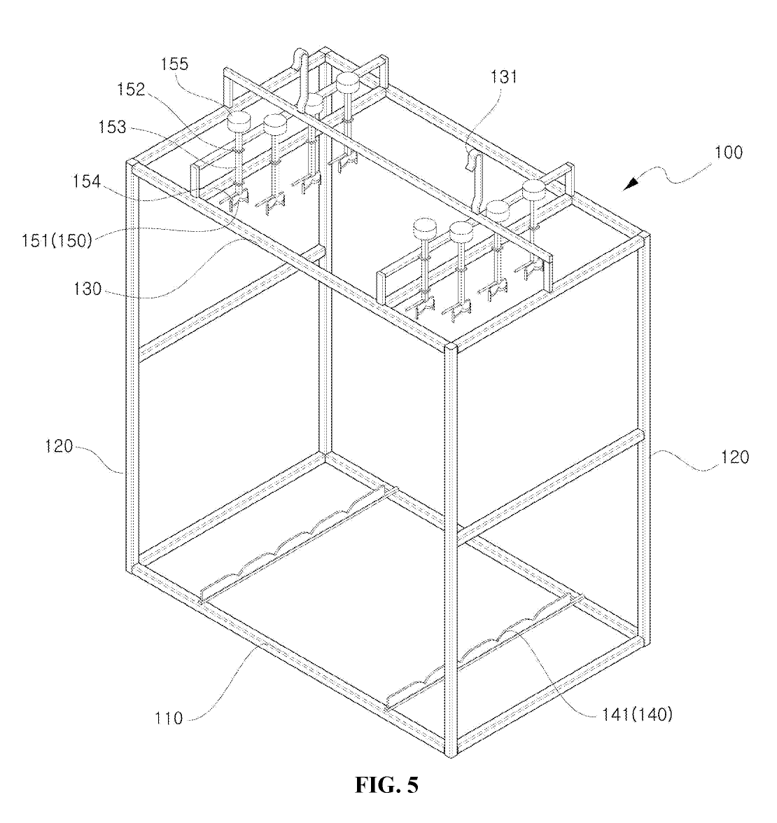

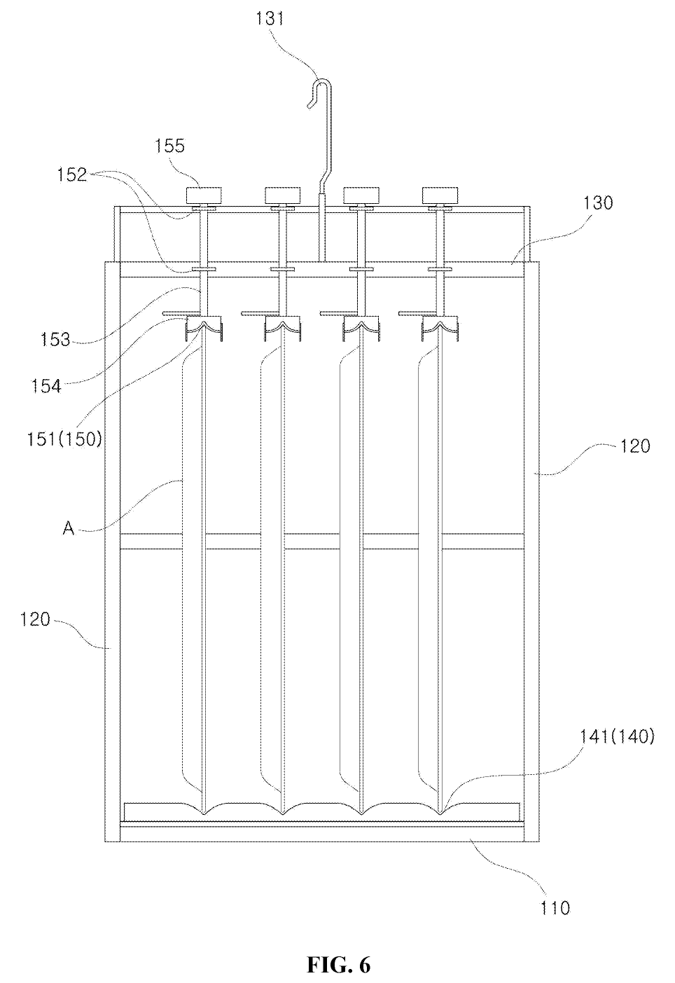

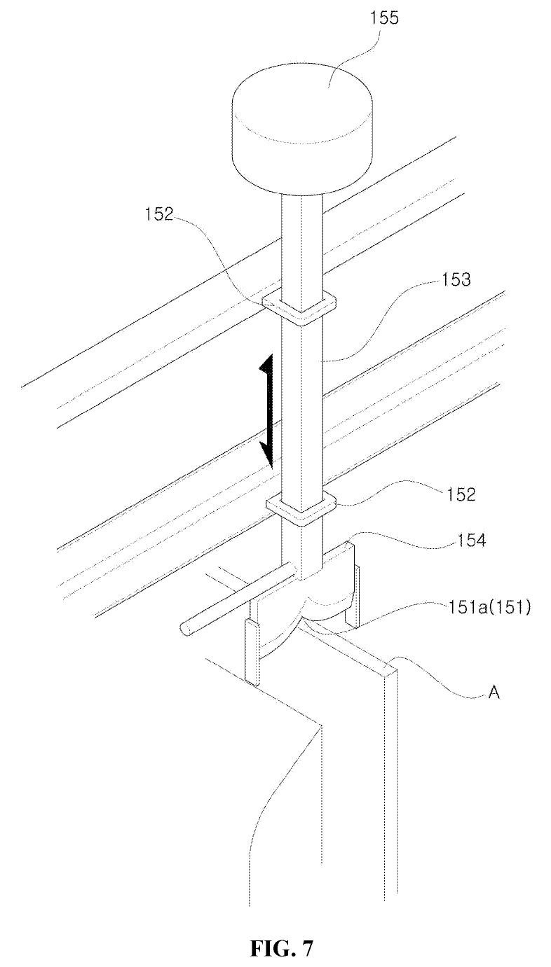

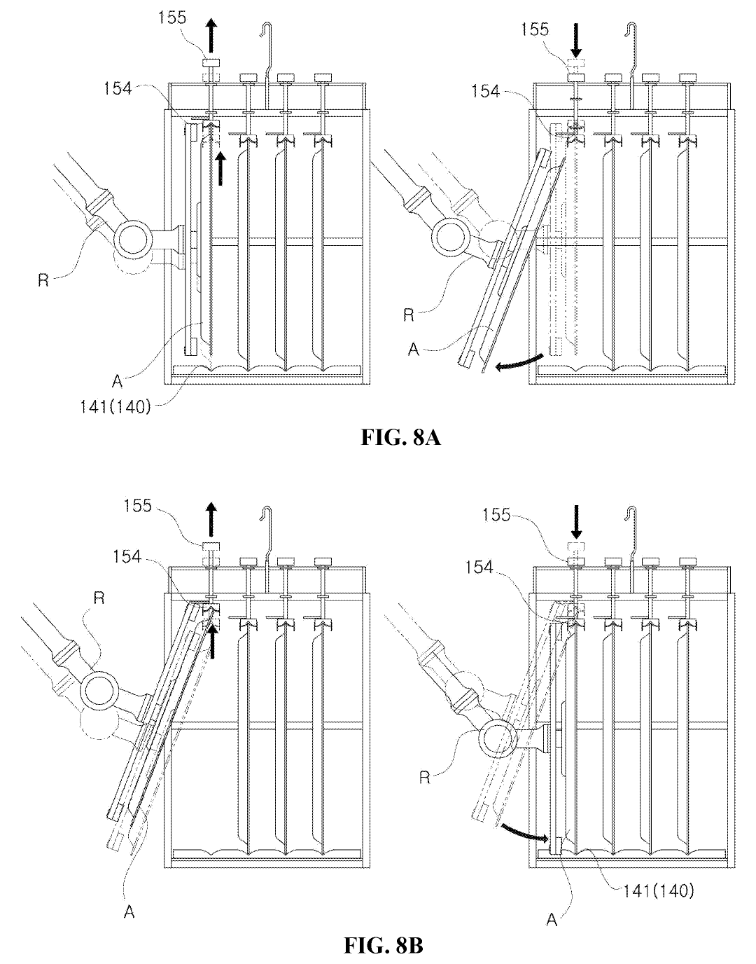

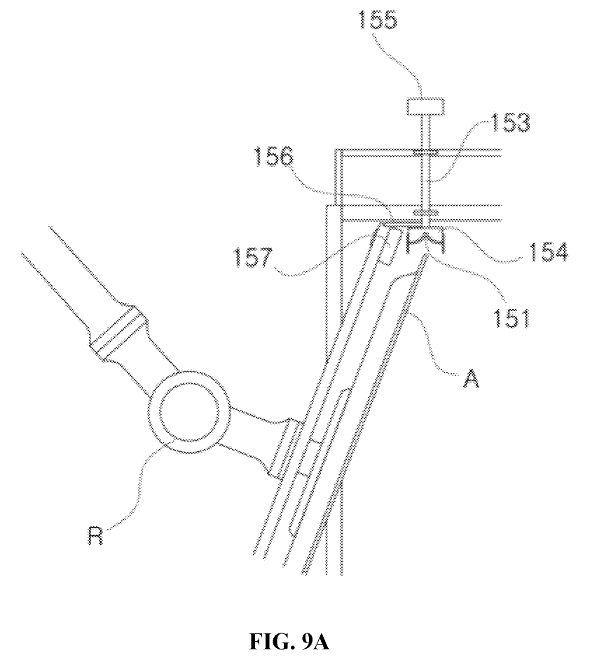

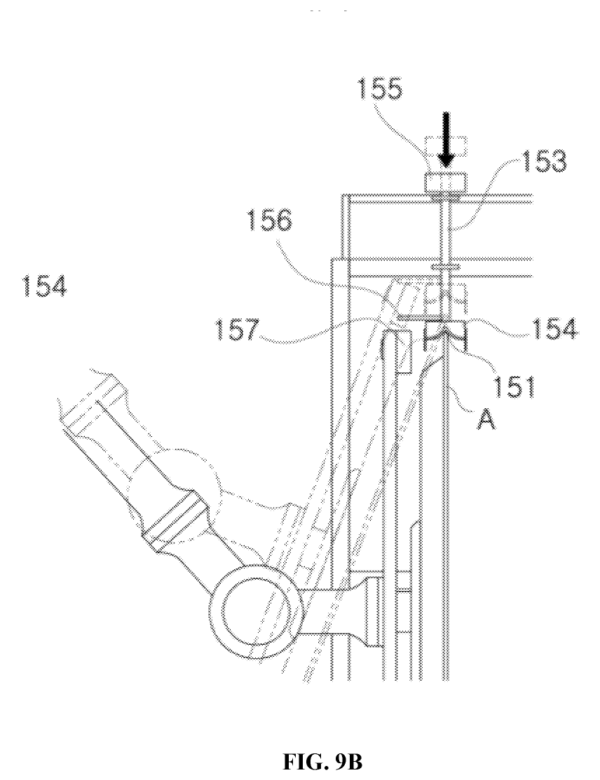

FIG. 1 is a perspective view showing a transfer carrier parking device according to the present disclosure, FIGS. 2A and 2B are side views showing a state where a transfer carrier is parked on the transfer carrier parking device according to the present disclosure, FIG. 3 is a photograph showing a zero point setter of the transfer carrier parking device according to the present disclosure, FIGS. 4A and 4B are photographs showing operating states of the zero point setter of the transfer carrier parking device according to the present disclosure, FIG. 5 is a perspective view showing the transfer carrier of the transfer carrier parking device according to the present disclosure, FIG. 6 is a front view showing the transfer carrier of the transfer carrier parking device according to the present disclosure, FIG. 7 is an enlarged perspective view showing a top spacer of the transfer carrier parking device according to the present disclosure, FIGS. 8A and 8B are side views showing a state where a workpiece is loaded and unloaded in and from the transfer carrier of the transfer carrier parking device according to the present disclosure, and FIGS. 9A and 9B are side views showing a lift pin and a robot pushing piece in the transfer carrier parking device according to the present disclosure.

The present disclosure relates to a transfer carrier parking device, and the transfer carrier parking device largely includes a transfer carrier 100 and a carrier setter 400 so that the transfer carrier 100 in which workpieces are loaded is pressed against a parking reference surface by means of setting blocks to allow a parking reference point to be set, thereby achieving automation in the setting process and improving a degree of precision in loading the workpieces by a robot arm.

According to the present disclosure, a parking zero point of a plurality of workpieces A loaded in the transfer carrier 100 is corrected by means of the carrier setter 400.

The carrier setter 400 includes a pair of first and second site guards 410 and 420 located on a parking site for the transfer carrier 100 in such a way as to be arranged in parallel with a parking direction of the transfer carrier 100, a third site guard 430 located on one side end of the first and second site guards 410 and 420 in such a way as to restrict a moving distance of the transfer carrier 100, a parking reference surface 440 located on the first site guard 410, and a pair of first setting blocks 450 located on the second site guard 420 in such way as to expandingly and contractedly move by means of setting cylinders 451 connected thereto to press the transfer carrier 100 toward the parking reference surface 440.

The parking site means a designated area for parking the transfer carrier 100.

The first and second site guards 410 and 420 have slant guides on the entrances thereof to guide the transfer carrier 100 to a space therebetween.

The transfer carrier 100, which is received in the space between the first and second site guards 410 and 420, is stopped in a state of coming into close contact with the third site guard 430 and then restrained by means of the pair of first setting blocks 450 located on the first site guard 410.

As shown in FIG. 1, if the transfer carrier 100 is pressed toward the parking reference surface 440 by means of the first setting blocks 450 in the space between the first and second site guards 410 and 420, a parking reference point of the transfer carrier 100 is simply set to achieve the automation in the setting process and improve a degree of precision in loading workpieces A by means of a robot arm.

As shown in FIGS. 2A and 2B, a second setting block 452 is located on one side first setting block 450 and has a slant setting surface 453 on one side thereof.

While the transfer carrier 100 is pressed toward the parking reference surface 440 by means of expanding transfer forces of the first setting blocks 450, the slant setting surface 453 of the second setting block 452 serves to press one side frame 120 of the transfer carrier 100 against the third site guard 430.

Like this, the transfer carrier 100 is pressed toward the parking reference surface 440 by means of the first setting blocks 450 in the space between the first and second site guards 410 and 420, the slant setting surface 453 presses one side frame 120 of the transfer carrier 100 against the third site guard 430, thereby setting the parking reference point perpendicular to the parking reference surface 440.

As shown in FIG. 3, the workpieces A loaded in the transfer carrier 100 are unloaded individually by means of the robot arm R, and each unloaded workpiece A’s loading zero point is corrected by means of a zero point setter 460.

The zero point setter 460 includes a setting board 461 for temporarily seating the plate-shaped workpiece A transferred through the robot arm R thereonto and having a given inclination in such a way as to be kept in posture to allow one side corner of the workpiece A to be located toward a lower portion thereof, first and second setting guides 463 and 463’ arranged to become reduced in distance therebetween toward the lower portion thereof to guide the two neighboring sides of the workpiece A, while being spaced apart from each other on lower ends thereof in such a way as to form a detection space portion 462 allowing the corner of the lower portion of the workpiece A to be exposed to the outside, and first and second setting sensors 464 and 464’ for detecting the positions of the two sides of the workpiece A exposed through the detection space portion 462 in a state of coming into surface contact with the first and second setting guides 463 and 463’.

A loading reference point of the robot arm R is set with respect to the position of the workpiece A corrected in loading posture by means of the first and second setting guides 463 and 463’.

Referring to the operations of the zero point setter 460, the workpieces A loaded in the transfer carrier 100 are clamped and unloaded individually by the robot arm R and seated onto the setting board 461, and next, if each workpiece A is unclamped from the robot arm R, the workpiece A moves downward along the first and second setting guides 463 and 463’ by means of its self-weight and is corrected in loading posture, as shown in FIGS. 4A and 4B.

After that, if the workpiece A is detected by means of the first and second setting sensors 464 and 464’, the robot arm R moves to the loading reference point, clamps the workpiece A, and is then transferred to a process line.

Like this, the workpiece A, which is unloaded from the transfer carrier 100 by means of the robot arm R, is corrected in clamping position through the zero point setter 460, thereby advantageously improving a degree of precision in automated loading process through the robot arm R.

According to the present disclosure, as shown in FIGS. 5 and 6, the transfer carrier 100 includes a bottom frame 110, side frames 120, and a top frame 130.

The bottom frame 110 is provided in the form of a rectangular frame by connecting horizontal bars and vertical bars arranged in a transverse direction.

The side frames 120 are erected on both sides of the bottom frame 110.

One pair of side frames 120 is facingly arranged, and lower end portions of the side frames 120 are connected to both side corners of the bottom frame 110.

The top frame 130 is located on tops of the side frames 120 and has carrier hooks 131.

The top frame 130 is arranged in parallel to the bottom frame 110, and the plate-shaped workpieces A are erectedly received in a space between the top frame 130 and the bottom frame 110.

According to the present disclosure, the transfer carrier 100 further includes bottom spacers 140 located on the bottom frame 110 and each having a plurality of bottom jig grooves 141 adapted to receive the undersides of the workpieces A erectedly placed in the transfer carrier 100.

In this case, one pair of bottom spacers 140 is spaced apart from each other in a longitudinal direction of the bottom frame 110, and the plurality of bottom jig grooves 141 are formed on tops of the bottom spacers 140 in a transverse direction of the bottom frame 110.

The workpieces A, which are erected in the transfer carrier 100, are received in the bottom jig grooves 141 of the bottom spacers 140 in such a way as to be spaced apart from one another at given intervals.

According to the present disclosure, the transfer carrier 100 further includes top spacers 150 spaced apart from one another on the top frame 130 in such a way as to correspond to the bottom jig grooves 141, movable in a longitudinal direction, and each having a top jig groove 151 adapted to receive the top of the corresponding workpiece A therein.

In this case, a plurality of pairs of top spacers 150 are spaced apart from one another in a longitudinal direction of the top frame 130, and each top spacer 150 has the top jig groove 151 in a transverse direction of the top frame 130.

As shown in FIG. 7, each top spacer 150 includes sleeves 152 mounted on the top frame 130, a rod 153 inserted into the sleeves 152 in such a way as to linearly move in a longitudinal direction, a top jaw 154 disposed on the underside of the rod 153 and having the top jig groove 151 on the underside thereof, and a weight 155 disposed on top of the rod 153 in such a way as to press the rod 153 downward.

A downward transfer force of the rod 153 is generated due to the self-weight of the weight 155, and together with the rod 153, the top jaw 154 moves downward to restrain the top of the workpiece A thereby.

As the rod 153 is pressed against the weight 155, further, a downward pressing force is consistently generated within the movable range in the longitudinal direction thereof.

If the workpiece A is loaded and unloaded by means of the robot arm R, the top jaw 154 moves upward according to the operation of the robot arm R so that a downward repulsive force applied to the top jaw 154 by the weight 155 is consistently maintained to minimize frictional resistance between the workpiece A and the top jaw 154 and prevent the workpiece A from being damaged due to the repulsive force of the top jaw 154.

The workpiece A that is loaded in the space between the top spacers 150 and the bottom spacers 140 is restrained by the top jig grooves 151 of the top jaws 154 that move downward by means of the weights 155.

If the workpiece A restrained in the space between the top spacers 150 and the bottom spacers 140 moves upward, further, the top jaws 154 move upward together with the workpiece A to allow the workpiece to be released from the restrained state.

Further, the bottom jig grooves 141 and the top jig grooves 151 are V-shaped grooves.

If the workpiece A is restrained by the top spacers 150 and the bottom spacers 140, top and underside of the workpiece A are corrected in position to the centers of the V-shaped grooves as the bottom jig grooves 141 and the top jig grooves 151.

If the workpiece A restrained by the top spacers 150 and the bottom spacers 140 is automatically unloaded by means of the robot arm R, as a result, the workpiece A is clamped accurately by the robot arm R.

As shown in FIG. 7, the top jig groove 151 has a grasping edge 151a on the inner peripheral surface thereof.

The grasping edge 151a has the shape of a blade so that it grasps top of the workpiece A.

If the top jaws 154 of the top spacers 150 move downward to receive the workpiece A into the top jig grooves 151, the grasping edges 151a grasp top of the workpiece A in a perpendicular direction to the workpiece A to thus prevent the workpiece A from moving in a transverse direction.

In the case where the transfer carrier 100 in which the workpieces A are placed moves, as a result, the workpieces A are firmly restrained at their initial position when loaded in the transfer carrier 100, so that in the process of unloading the workpieces A from the transfer carrier 100 by means of the robot arm R, advantageously, the workpieces A are clamped in their right position.

Referring to a process of unloading the workpiece A from the transfer carrier 100 by means of the robot arm R, as shown in FIG. 8A, the workpiece A placed in the transfer carrier 100 is clamped by a suction pad of the robot arm R and thus unloaded from the transfer carrier 100.

In a state where the suction pad of the robot arm R is sucked onto one side surface of the workpiece A, if the workpiece A moves upward together with the top jaws 154 by means of the robot arm R, the underside of the workpiece A becomes separated from the bottom jig grooves 141.

Next, the workpiece A becomes inclined at a given angle by means of the robot arm R so that the underside of the workpiece A is separated from the bottom jig grooves 141 to the outside.

If the workpiece A moves downward by means of the robot arm R, the top of the workpiece A is separated from the top jig grooves 151 to the outside so that the workpiece A is unloaded from the transfer carrier 100 to the outside.

Referring to a process of loading the workpiece A in the transfer carrier 100 by means of the robot arm R, as shown in FIG. 8B, the workpiece A is clamped by the suction pad of the robot arm R and thus loaded in the transfer carrier 100.

In this case, the suction pad of the robot arm R is sucked onto one side surface of the workpiece A, and in a state where the workpiece A is inclined at a given angle, next, it is put into the space between the top spacers 150 and the bottom spacers 140.

After that, in a state where the top of the workpiece A is received in the top jig grooves 151 by means of the robot arm R, the workpiece A moves upward together with the top jaws 154, and if the workpiece A is corrected perpendicularly in position and then moves downward by means of the robot arm R, next, the underside of the workpiece A is received in the bottom jig grooves 141 and restrained thereby.

As the top spacers 150 move in the longitudinal direction, like this, downward pressing forces are generated by means of the weights 155 in a direction of gravity, so that only through an upward motion of the robot arm R, a distance between the top spacers 150 and the bottom spacers 140 is expanded and contracted to clamp and unclamp the workpiece A, thereby achieving automation in the processes of loading and unloading the workpiece A in and from the transfer carrier 100 by means of the robot arm R.

As shown in FIGS. 9A and 9B, a lift pin 156 is disposed on one side of the rod 153 or top jaw 154, and the robot arm R has a robot pushing piece 157 at a position corresponding to the lift pin 156.

If it is desired to load the workpiece A in the transfer carrier 100, the workpiece A is clamped by the robot arm R and loaded in the transfer carrier 100, and next, if the workpiece A moves upward at positions corresponding to the top spacers 150 and the bottom spacers 140, the lift pins 156 are pressed against the robot pushing pieces 157 to allow the top jaws 154 to move upward so that the top jig grooves 151 and the workpiece A are kept separated from each other.

If the workpiece A is corrected perpendicularly in position and then moves downward by means of the robot arm R, next, the underside of the workpiece A is received in the bottom jig grooves 141, and after that, the upward pressing forces of the robot pushing pieces 157 against the lift pins 156 are released to allow the top jaws 154 to move downward so that the workpiece A is restrained by the top jig grooves 151.

Like this, the top jaws 154 move upward according to the upward movement of the robot arm R through the lift pins 156 and the robot pushing pieces 157 to allow the top jig grooves 151 and the workpiece A to be separated from each other, so that in the process of loading the workpiece A in the transfer carrier 100, the workpiece A is prevented from being damaged due to its friction against the top jaws 154.

As described above, the transfer carrier parking device of the present disclosure is configured to be structurally improved so that the transfer carrier in which the workpieces are loaded is pressed toward the parking reference surface by means of the setting blocks to allow the parking reference point to be set, thereby achieving the automation in the setting process and improving a degree of precision in loading the workpieces by the robot arm.

While the present disclosure has been made with reference to the particular illustrative embodiments, it is not to be restricted by the embodiments but only by the appended claims. It is to be appreciated that those skilled in the art can change or modify the embodiments without departing from the scope and spirit of the present disclosure.

1. A transfer carrier parking device comprising:
a transfer carrier (100) in which a plurality of workpieces (A) are loaded; and
a carrier setter (400) adapted to correct a parking zero point for the workpieces (A) and comprising a pair of first and second site guards (410 and 420) located on a parking site for the transfer carrier (100) in such a way as to be arranged in parallel with a parking direction of the transfer carrier (100), a third site guard (430) located on one side end of the first and second site guards (410 and 420) in such a way as to restrict a moving distance of the transfer carrier (100), a parking reference surface (440) located on the first site guard (410), a pair of first setting blocks (450) located on the second site guard (420) in such way as to expandingly and contractedly move by means of setting cylinders (451) connected thereto to press the transfer carrier (100) toward the parking reference surface (440), and a second setting block (452) located on one side first setting block (450) and having a slant setting surface (453) on one side thereof,
wherein while the transfer carrier (100) is pressed toward the parking reference surface (440) by means of expanding transfer forces of the first setting blocks (450), the slant setting surface (453) of the second setting block (452) serves to press one side frame (120) of the transfer carrier (100) against the third site guard (430).

2. The transfer carrier parking device according to claim 1, further comprising a zero point setter (460) adapted to correct a loading zero point of each workpiece (A) unloaded from the transfer carrier (100) by means of a robot arm (R), the zero point setter (460) comprising:
a setting board (461) for temporarily seating the plate-shaped workpiece (A) transferred through the robot arm (R) thereonto and having a given inclination in such a way as to be kept in posture to allow one side corner of the workpiece (A) to be located toward a lower portion thereof;
first and second setting guides (463 and 463’) arranged to become reduced in distance therebetween toward the lower portion thereof to guide the two neighboring sides of the workpiece (A), while spaced apart from each other on lower ends thereof in such a way as to form a detection space portion (462) allowing the corner of the lower portion of the workpiece (A) to be exposed to the outside; and
first and second setting sensors (464 and 464’) for detecting the positions of the two sides of the workpiece (A) exposed through the detection space portion (462) in a state of coming into surface contact with the first and second setting guides (463 and 463’).

3. The transfer carrier parking device according to claim 2, wherein the robot arm (R)’s loading reference point is set with respect to the position of the workpiece (A) corrected in loading posture by means of the first and second setting guides (463 and 463’), and after each workpiece (A) is clamped by the robot arm (R), unloaded from the transfer carrier (100), and seated onto the setting board (461), if each workpiece (A) is unclamped from the robot arm (R), the workpiece (A) moves downward along the first and second setting guides (463 and 463’) by means of self-weight thereof and is corrected in loading posture, so that if the workpiece (A) is detected by means of the first and second setting sensors (464 and 464’), the robot arm (R) moves to the loading reference point, clamps the workpiece (A), and is then transferred to a process line.

4. The transfer carrier parking device according to claim 1, wherein the transfer carrier (100) comprises:
a bottom frame (110);
side frames (120) erected on both sides of the bottom frame (110);
a top frame (130) located on tops of the side frames (120) and having carrier hooks (131);
bottom spacers (140) located on the bottom frame (110) and each having a plurality of bottom jig grooves (141) adapted to receive the undersides of the workpieces (A) therein, the workpieces (A) being erectedly placed in the transfer carrier (100); and
top spacers (150) spaced apart from one another on the top frame (130) in such a way as to correspond to the bottom jig grooves (141), movable in a longitudinal direction thereof, and each having a top jig groove (151) adapted to receive the top of the corresponding workpieces (A) therein.

5. The transfer carrier parking device according to claim 4, wherein each top spacer (150) comprises:
sleeves (152) mounted on the top frame (130);
a rod (153) inserted into the sleeves (152) in such a way as to linearly move in a longitudinal direction;
a top jaw (154) located on the underside of the rod (153) and having the top jig groove (151) on the underside thereof; and
a weight (155) located on top of the rod (153) in such a way as to press the rod (153) downward.

6. The transfer carrier parking device according to claim 5, wherein the bottom jig grooves (141) and the top jig grooves (151) are V-shaped grooves, and if the workpieces (A) are restrained by the top spacers (150) and the bottom spacers (140), tops and undersides of the workpieces (A) are corrected in position to the centers of the V-shaped grooves as the bottom jig grooves (141) and the top jig grooves (151).

7. The transfer carrier parking device according to claim 6, wherein each top jig groove (151) has a grasping edge (151a) on the inner peripheral surface thereof in such a way as to grasp top of the workpiece (A) and thus restrain the workpiece (A) thereby.

8. The transfer carrier parking device according to claim 4, wherein the transfer carrier (100) further comprises a cart unit (210) adapted to support the underside of the transfer carrier (100) thereagainst and having a plurality of casters (211), a pair of base arms (213) having locking projections (212) adapted to receive the underside of the transfer carrier (100), and transverse bars (214) for connecting the base arms (213) to each other.

9. The transfer carrier parking device according to claim 5, wherein the workpiece (A) placed in the transfer carrier (100) is clamped by a suction pad of the robot arm (R), and in a state where the suction pad of the robot arm (R) is sucked onto one side surface of the workpiece (A), if the workpiece (A) moves upward together with the top jaws (154) by means of the robot arm (R), the underside of the workpiece (A) becomes separated from the bottom jig grooves (141) and is then inclined at a given angle by means of the robot arm (R), so that the underside of the workpiece (A) is separated from the bottom jig grooves (141) to the outside, and next, if the workpiece (A) moves downward by means of the robot arm (R), the top of the workpiece (A) is separated from the top jig grooves (151) to the outside and then unloaded from the transfer carrier (100).

10. The transfer carrier parking device according to claim 5, wherein the workpiece (A) is clamped by the suction pad of the robot arm (R), and in the state where the suction pad of the robot arm (R) is sucked onto one side surface of the workpiece (A), the workpiece (A) is inclined at a given angle, put between the top spacers (150) and the bottom spacers (140), and moves upward together with the top jaws (154) in a state where the top of the workpiece (A) is received in the top jig grooves (151) by means of the robot arm (R), so that if the workpiece (A) is corrected perpendicularly in position and then moves downward by means of the robot arm (R), the underside of the workpiece (A) is received in the bottom jig grooves (141) and restrained thereby.

11. The transfer carrier parking device according to claim 5, wherein the rod (153) or the top jaw (154) has a lift pin (156) on one side thereof, and the robot arm (R) has a robot pushing piece (157) at a position corresponding to the lift pin (156), so that to load the workpiece (A) in the transfer carrier (100), if the workpiece (A) is clamped by the robot arm (R), is inserted into the transfer carrier (100), and thus moves upward at positions corresponding to the top spacers (150) and the bottom spacers (140), the lift pins (156) are pressed against the robot pushing pieces (157) to allow the top jaws (154) to move upward, which causes the top jig grooves (151) and the workpiece (A) to be kept separated from each other, and if the workpiece (A) is corrected perpendicularly in position and then moves downward by means of the robot arm (R), next, the underside of the workpiece (A) is received in the bottom jig grooves (141) to allow the upward pressing forces of the robot pushing pieces (157) against the lift pins (156) to be released, which causes the workpiece (A) to be restrained by the top jig grooves (151) through the downward movement of the top jaws (154).
